(19) United States
(12) Patent Application Publication
(10) Pub. No.: US 2005/0098580 A1
(43) Pub. Date: May 12, 2005

(54) Dispenser container

(76) Inventor: Nick E. Ciavarella, Seven Hills, OH (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 10/702,334

(22) Filed: Nov. 6, 2003

(51) Int. Cl. B67D 5/06

(52) U.S. Cl. 222/183

(57) ABSTRACT

A container used in connection with a dispenser, the container having one or more projections extending outwardly therefrom and engagable with the interior of the dispenser to secure the container in the dispenser.

### RELATED PATENT APPLICATIONS

None.

### TECHNICAL FIELD OF THE INVENTION

In general, the present invention relates to dispensers for soap, lotion, or similar flowable material. More particularly, the present invention relates to a replaceable container used in such dispensers. Most particularly, the present invention relates to a container having one or more projections extending outwardly from it to secure the container within a dispenser.

### BACKGROUND OF THE INVENTION

Dispensers used to dispense flowable material such as foam, fluid or powdered soaps, lotions and other products, which, for simplicity, will collectively be referred to as “soap,” are widely used in home and commercial settings. These dispensers typically include a housing that mounts to a wall or other supporting surface. The housing may include a base that attaches to the wall and a cover that is separately attached to the base. A disposable container such as a bag or bottle is typically placed within the housing to store a supply of soap. A pump is associated with either the container or the housing and is used to selectively dispense soap from the container.

A wide variety of dispensers are available on the market and, in some cases, several types of dispensers will be used at a single location. Often times, these dispensers are designed to receive containers of a specific size. To provide a unique fit between the container and dispenser, the containers are keyed to a particular dispenser by way of a collar key that has a projecting key in a predefined shape that fits into an identically shaped keyway formed in a receiver within the dispenser housing. As a result, consumers having multiple dispensers must order multiple containers to refill those dispensers. To allow consumers to order a single container that could be used with a number of dispenser housings, it is desirable to create a container that lacks the collar key. In addition to providing the unique fit between container and dispenser, the collar key also serves to support and secure the container within the dispenser. Therefore there is a need for a container that bypasses the collar key system while providing proper fit within the dispenser housing.

### SUMMARY OF THE INVENTION

It is, therefore, an object of the present invention to provide a container that can be secured within a dispenser without a collar key.

In light of this object, the present invention generally includes a container having one or more projections extending outwardly therefrom for providing a snug fit between the container and the dispenser.

### BRIEF DESCRIPTION OF THE DRAWINGS

FIG. 1 is a perspective view of a dispenser according to the concepts of the present invention;

FIG. 2 is a perspective view similar to FIG. 1 with the cover of the dispenser depicted in an open position to show details of the container according to the concepts of the present invention;

FIG. 3 is a front elevational view of a container according to the concepts of the present invention; and

FIG. 4 is a side elevational view thereof.

### BRIEF DESCRIPTION OF THE PREFERRED EMBODIMENTS

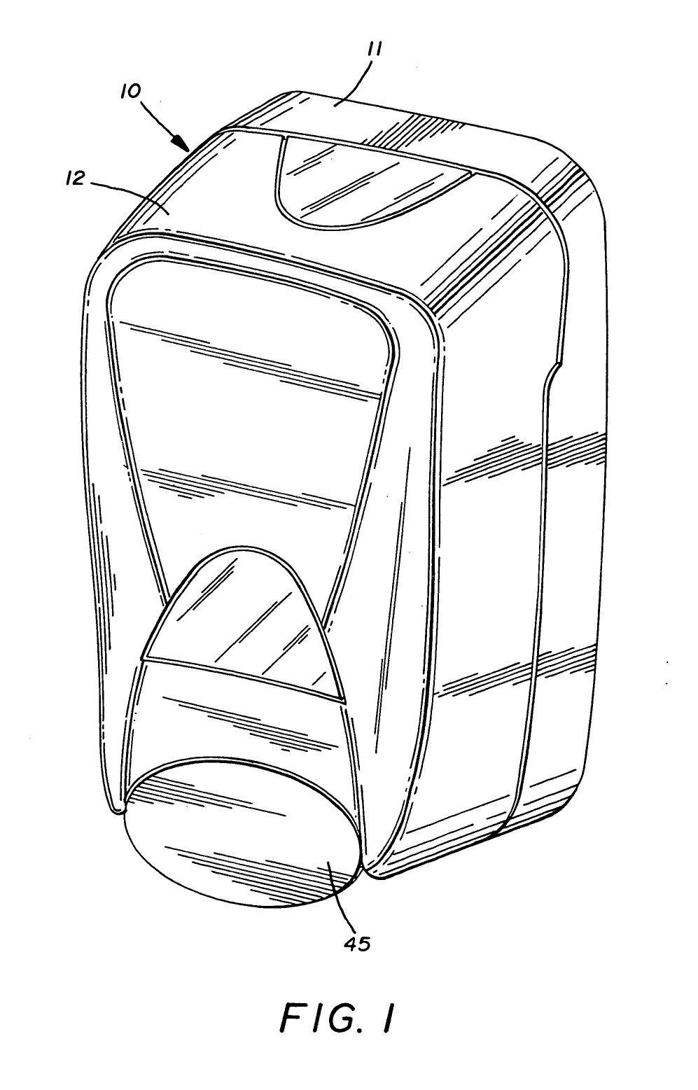

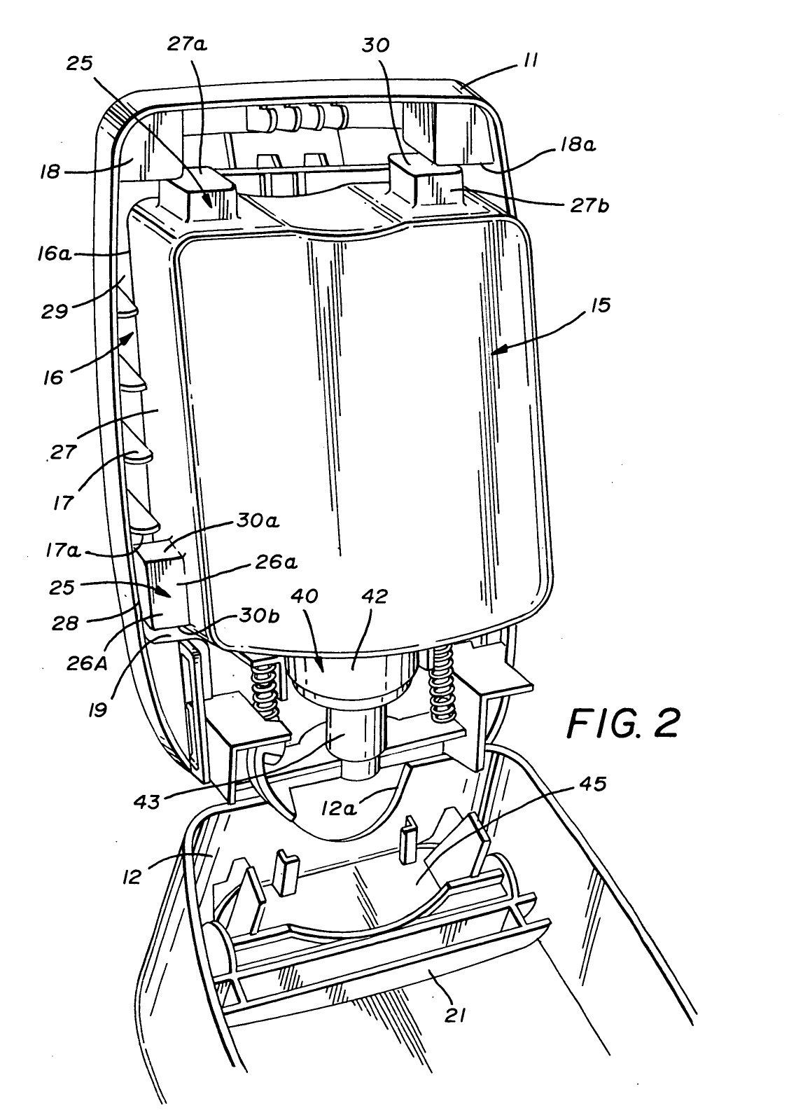

A dispenser, generally indicated by the numeral 10, is depicted in FIG. 1 of the drawings, the dispenser 10, shown, is but one example of a variety of dispensers available in the art. The dispenser 10 may include a base 11, which may be mounted on a supporting surface, and a cover 12. The cover 12 and base 11 may be hingedly attached to each other such that the cover 12 opens in a clamshell like fashion as shown in FIG. 2. The base 11 and cover 12 house a container, generally indicated by the numeral 15, that holds the soap that is to be dispensed.

In general, container 15 is a hollow body for holding soap and may be of any form including a bottle form, as shown. In the example shown, container 15 is a bottle type container having a front wall 15a and a back wall 15b joined by a pair of side walls 15c, a top 15d, and a bottom 15e. While the container 15 is shown without a vent, a vent may be provided in container 15 to facilitate its use with various pumps available in the art.

As described previously, dispensers 10 are used to dispense flowable materials such as fluids and powders including soaps, lotions, and hand sanitizers among others. For simplicity, these flowable products will be collectively referred to as “soap.” Returning to FIG. 2, the base 11 may define a recess, generally indicated by the numeral 16, for receipt of the container 15. As shown, the base 11 may define the recess 16 through a number of structures such as ribs 17, corner bolsters 18, and shoulders 19. It will be appreciated, however, that some recesses may be formed from a continuous surface or wall within the base 11.

The cover 12 may simply fit over the container 15 and base 11, or, as shown in FIG. 2, may incorporate a support 21 that fits below the container 15 to aid the base 11 in supporting the container 15. Thus, in some designs, the cover 12 and base 11 may cooperate to form the recess 16 for receiving the container 15. As will be appreciated the cover 12 may use the same structures 17, 18 and 19. As base 11 to define the recess 16, and, thus, for simplicity, discussion of the recess 16 in terms of the base 11 equally may apply to cover 12. Of course some covers 12 may not have recess-forming structures and are included within the present invention.

As described above, a wide variety of dispensers 10, have been developed. The interiors of each may vary as attempts have been made to maximize the container volume within the dispenser 10.

To ensure that the container 15 is secured within the dispenser 10, one or more projections, generally indicated by the numeral 25, extend outwardly from the container 15. In general, projection 25 may secure the container 15 by forming an interference fit with the dispenser 10 or interact with surfaces within the dispenser 10 to provide a positive stop to any undesired movement. To create an interference fit, the projection 25 effectively oversizes the container 15 relative to the recess 16. In this way, some deformation of the projection 25 or container 15 may occur when inserting the container 15 within the recess 16. As a result, projection 25 or container 15 may exert an outward force against the portion of the dispenser 10, in which it is in contact, holding the container 15 in place. Alternatively, the interference fit is formed by frictional contact between the projection 25 and a wall of the dispenser 10. Since a very minimal force may be necessary to hold the container 15 in place, the frictional forces between the projection 25 and dispenser 10 may be sufficient without any need for deformation of the projection 25. For simplicity, both modes will be referred to as an interference fit.

The projection 25 may further act as a positive stop by extending from container 15, such that, one or more of its surfaces contacts a surface within the dispenser 10 to oppose undesired movement of the container 15. For example, contact between a laterally extending surface of the dispenser 10, such as the lower surface 18a of bolster 18 or lower surface 17a of rib 17, and a laterally extending surface 30 of projection 25, such as an upper or lower surface 30a, 30b of a projection 25, may be used to prevent longitudinal movement of the container 15. In the example shown in FIG. 2, the projections 25 extend outward from the container 15 sufficiently to face the lower lateral surfaces 17a, 18a of the dispenser 10. In this way, axial displacement of the container 15 is limited by the projections 25 contacting one of these surfaces 17a, 18a. Similarly, a longitudinally extending surfaces 31 may interact with the sides 28 of the dispenser to prevent lateral movement of the container 15. As shown, the surfaces 30, 31 of the projections 25 may be oriented perpendicular to the longitudinal and lateral axes (A, B) of the container to respectively stop longitudinal and lateral movement of container 15. Thus, in general, the projection 25 replaces a collar key assembly by providing resistance, in the form of an interference fit or positive stop, to undesired movement of the container 15. Thus, container 15 may be formed without a collar key.

Considering the given example in more detail, with reference to FIG. 2, the projections 25 may extend laterally outward and/or longitudinally outward from the container 15. In the example shown, a first lateral projection 26a extends laterally outward from one side 15c of container 15 toward the sidewall 28 of base 11. As shown, the projection 25 may be sized to fit between structures within the base 11, such as ribs 17. The projection 25 may have any shape including the somewhat cubed shape shown.

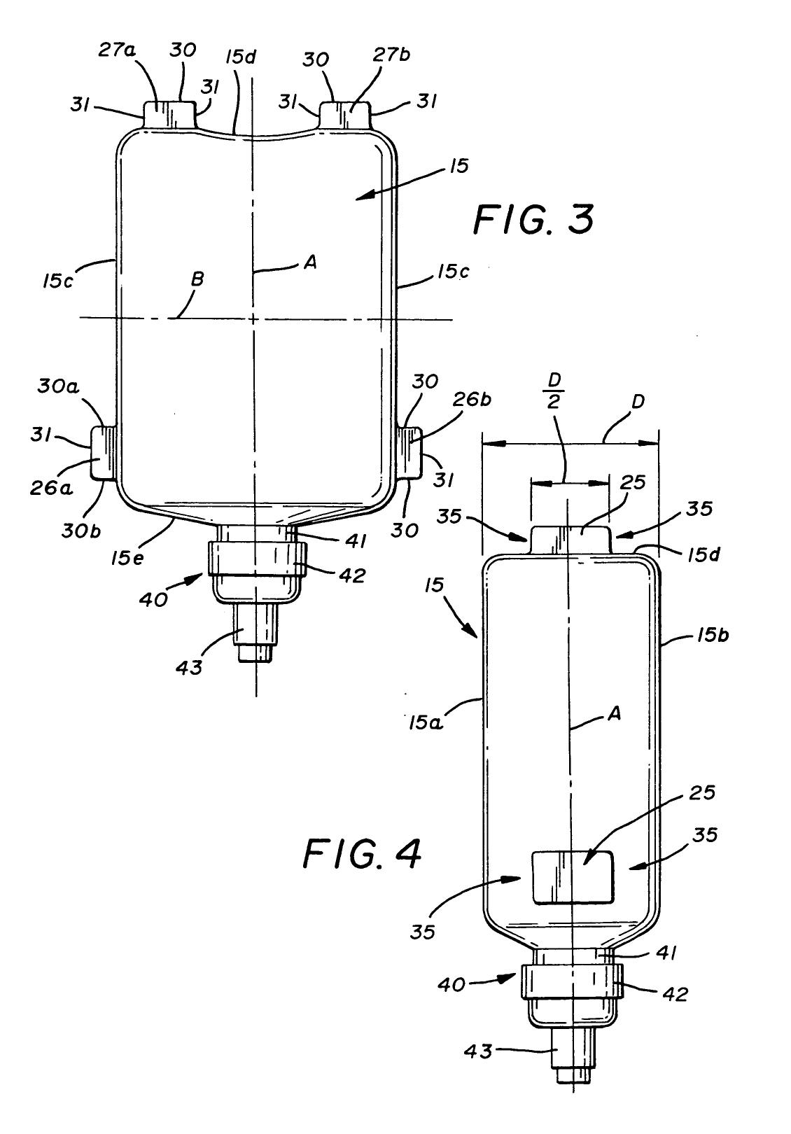

As best shown in FIG. 3, a second laterally extending projection 26b may extend outwardly from the side opposite the first laterally extending projection 26a. The laterally extending projections 26a, 26b are arranged opposite each other and may be symmetrically located relative to the longitudinal axis A of the container 15.

A pair of longitudinally extending projections 27a, 27b may extend from the top surface 31 of the container 15. These projections 27a, 27b may resemble laterally extending projections 26a, 26b and also may be arranged symmetrically relative to the longitudinal axis A. While not shown, it will be appreciated that similar projections may extend from the bottom 15e of the container 15 to achieve the same effect. As best shown in FIG. 2, the longitudinally extending projections 27a, 27b may extend upwardly from the top surface 15d toward respective corner bolsters 18. In this way, the container 15, is snugly fit within the base 11 through the contact of the projections 25 with the sidewall 28 or other structure, such as bolster 18, within the base 11. It will be appreciated that such contact may likewise be established with other structures within the base 11 or cover 12.

Recognizing that the recess 16 is often formed centrally within the base 11 with a rim 29 extending outward from the mouth 16a of the recess 16. The projection 25 may have a depth-wise dimension less than that of the container 15. For example, as shown in FIG. 4, the projections 25 may be located medially relative to the front and rear walls 15a, 15b of the container 15. In the example shown, the projections 25 extend along only a portion of the depth D of the container 15 such that a clearance 35 is formed adjacent to the projection 25. In the example shown, with a centrally located projection 25, the clearance 35 is formed on either side of the projection 25 to the front and rear of the container 15. While the depth of projection 25 may be of any depth suitable for a given container, the example projections 25 have a depth equal to one-half the depth D of the container 15 to form equal clearances 35 to the front and rear of the projection 25. As an added benefit, in addition to preventing interference with the proper seating of the container 15, the projection 25 may be used to properly locate the container in the depthwise direction and properly align the pump 40, described more completely below with a discharge opening 12a formed in the cover 12.

The pump 40 may be attached to the container 15 in any manner known in the art, and likewise be of any form. In the example shown, the pump 40 is a plunger-type pump and extends downwardly from the bottom 15e of the container 15. In this example, the container 15 is provided with a neck 41 that extends downwardly from the bottom 15e of container 15. The pump 40 is attached by a cap 42 that fits over and threads onto the neck 41. The pump 40 includes a nozzle 43 that is slidably mounted within the cap 42 such that it is movable to selectively discharge soap from the container 15. As best shown in FIGS. 1 and 2, the cover 12 may be provided with a handle 45 that may be pushed or pulled to actuate the pump nozzle 43. As described previously, the projections 25, 26 may help locate the nozzle 43 within an opening 12a formed in the cover 12 of the dispenser.

Advantageously, the container 15 provided with the projections 25 will fit snugly within the base 11 without the need for a collar key that is often used to position and secure the container within the dispenser 10. By avoiding the use of the collar key, the container 15 of the present invention may be used with a variety of dispensers without regard to the proprietary keying systems used in the collar key designs. In other words, projections 25 secure the container, laterally and/or longitudinally, without a key.

While a full and complete description of the invention has been set forth in accordance with the dictates of the Patent Statutes, it should be understood that modifications can be resorted to without departing from the spirit hereof or the scope of the appended claims.

1. A container for a soap dispenser, the dispenser having a structure that defines a recess, the container comprising:
a) a hollow body adapted to fit within the recess;
b) a projection for limiting movement of the body within the dispenser, said projection extending outwardly from said body toward the structure of the dispenser for selective engagement therewith.

2. The container of claim 1, wherein said projection extends laterally outward from said body.

3. The container of claim 1, wherein said projection extends longitudinally outward from said body.

4. The container of claim 1, wherein said body includes a pair of projections extending outward from said body in opposite directions relative to each other.

5. The container of claim 1, wherein said body has a longitudinal axis and a second projection, wherein said projections are symmetrically located on said body relative to the longitudinal axis.

6. The container of claim 5, wherein said projections extend an equal distance from said body.

7. The container of claim 1, wherein said projection has a laterally extending surface oriented perpendicular to a longitudinal axis of said body.

8. The container of claim 1, wherein said projection has a surface extending perpendicular to a lateral axis of said body.

9. The container of claim 1, wherein said projection has a surface extending parallel to a longitudinal axis of said body and a surface extending perpendicular to the longitudinal axis of said body, wherein said surfaces are adapted to engage the dispenser.

10. A container for soap comprising:
a) a body having a top, a bottom, a front, a rear, and opposing sides connecting said top to said bottom and said front to said rear, said body having a longitudinal axis and a depth, wherein said body is made hollow to receive the soap;
b) a pair of longitudinal projections extending outward from said body in a direction parallel to the longitudinal axis of said body;
c) a pair of lateral projections extending laterally outward from said body;
d) a pump attached to said body and in fluid communication therewith for selectively discharging the soap from said body; and
e) wherein said pairs of projections are symmetrically arranged on said body relative to the longitudinal axis.

11. The container of claim 10, wherein said longitudinal projections extend from a top surface of said body.

12. The container of claim 10, wherein said lateral projections extend from opposite sides of said body.

13. The container of claim 10, wherein said projections are located between said front and said rear of said body and have a depth of about one-half of a depth of said body.

14. The container of claim 10, wherein said projections extend across only a portion of said depth defining a clearance.

15. The container of claim 14, wherein said projections are centered in the depthwise direction, whereby said clearance is defined on front and rear sides of or said projection.

16. The container of claim 10, wherein said projections have a substantially cubed shape.

17. A container for soap used in connection with a keyed dispenser, the container comprising:
a hollow body for receiving the soap;
a projection extending laterally from said body and engageable with the interior of the dispenser to laterally restrict movement of the container; and
a projection extending longitudinally from said body and engageable with the interior of the dispenser to longitudinally restrict movement of the container without a key.
